(19) United States
(12) Patent Application Publication
(10) Pub. No.: US 2007/0166619 A1
(43) Pub. Date: Jul. 19, 2007

(54) Lead acid batteries with plates that contain silver

(76) Inventor: Maureen Kerchner, Lenhartsville, PA (US)

Correspondence Address: Zachary T. Wobensmith, III, 7746 101st Court, Vero Beach, FL, 32967-2871, US

(21) Appl. No.: 11/332,385

(22) Filed: Jan. 17, 2006

(51) Int. Cl. H01M 4/62; H01M 10/06

(52) U.S. Cl. 429/232; 252/182.1; 429/225

(57) ABSTRACT

Lead acid batteries of the gel, or absorbment glassmat (AGM) type with lead plates that have a silver content in the range of 19 to 185 PPM, which silver enhances their performance.

### BACKGROUND OF THE INVENTION

1. Field of the Invention

This invention relates to lead acid batteries, which have battery plates that include a moderate silver content which enhances their performance.

2. Description of the Prior Art

The use of silver in batteries is known in the prior art. Silver has been used in silver oxide batteries for some time. It has not been used as an additive to the lead paste used to make the plates in gel and absorbent glassmat (AGM) lead acid batteries. It is desirable to improve the performance of lead acid batteries. Experiments have demonstrated that the addition of a moderate amount of silver to the lead paste, which forms the plates of a lead acid battery of the gel or AGM type results in improved performance.

### SUMMARY OF THE INVENTION

This invention relates to lead acid batteries of the gel or absorbment glassmat (AGM) type, which batteries have had a selected amount of silver added to the battery plates which results in improved performance.

The principal object of the invention is to provide lead acid batteries having battery plates containing a selected amount of silver.

A further object of the invention is to provide batteries that are reliable in operation.

A further object of the invention is to provide batteries that have improved performance.

A further object of the invention is to provide batteries of the character aforesaid which are suitable for mass production.

A further object of the invention is to provide batteries of the character aforesaid, which may be of the gel or AGM type.

Other objects and advantageous features of the invention will be apparent from the description and claims.

### DESCRIPTION OF THE DRAWINGS

The nature and characteristic features of the invention will be more readily understood from the following description taken in connection with the accompanying drawings forming part hereof in which:

FIG. 1 is a graph of the performance results of the gel batteries of the invention versus quality control data;

FIG. 2 is a graph of the performance test results for the AGM batteries of the invention versus quality control data;

FIG. 3 is a table of the 90-day shelf test results for the AGM batteries versus quality control data;

FIG. 4 is a table of the 90-day shelf test results for the gel batteries versus quality control data;

FIG. 5 is a graph of the CATV life test results for the gel batteries with different levels of silver;

FIG. 6 is a graph of the CATV life test results of the AGM batteries;

FIG. 7 is a graph of the 2-hour life cycle test results for the gel batteries, and,

FIG. 8 is a graph of the 2-hour life cycle test results for the AGM batteries.

It should, of course, be understood that the description and drawings herein are merely illustrative and that various modifications and changes can be in the formulas methods and structures disclosed without departing from the spirit of the invention.

### DESCRIPTION OF THE PREFERRED EMBODIMENTS

When referring to the preferred embodiments, certain terminology will be utilized for the sake of clarity. Use of such terminology is intended to encompass not only the described embodiments, but also technical equivalents, which operate and function in substantially the same way to bring about the same result.

In order to determine if the performance of lead-acid batteries of the gel type or the absorbent glass mat (AGM) type is improved by the addition of silver to the battery plates, experiments were conducted for both the gel and AGM batteries, using three different test levels of silver, and two batteries for each level of silver.

The levels of silver selected were 19 PPM, 67 PPM and 185 PPM, (PPM=particles per million), and the batteries tested were 8G24 group (gel type), and 8A24 group (AGM type), with the performance test results tabulated for the two batteries that were constructed for each level of silver.

The silver was added to the oxide used to make the paste by doping the molten lead with silver metal. The lead oxide was then manufactured in the conventional manner. The lead oxide was then mixed into lead paste in conventional manner, and pasted onto battery plates in conventional manner. The paste mixing showed no adverse affects due to the addition of silver. The plates then went through formation milling, and lug brushing. The plates were subjected to analyses for silver content, XRD, and free lead. The plates were weighed, grouped and stacked. The plates for the 8G24 group and 8A24 group of batteries were assembled into batteries, two for each selected level of silver, and tests for each group of batteries were conducted to evaluate them.

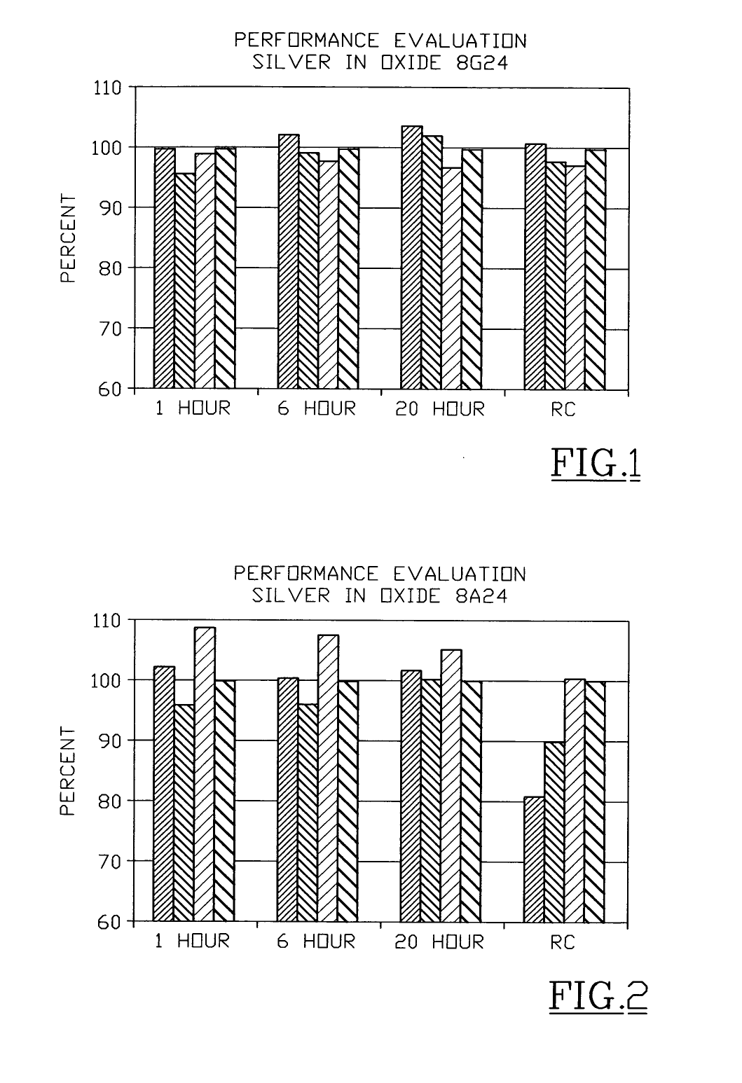

Referring to FIG. 1, performance results for the 8G24 group batteries versus quality control data did not show any drastic changes with increasing levels of silver.

Referring to FIG. 2, the performance results for the 8A24 group batteries versus quality control data did not show any drastic changes with increasing levels of silver.

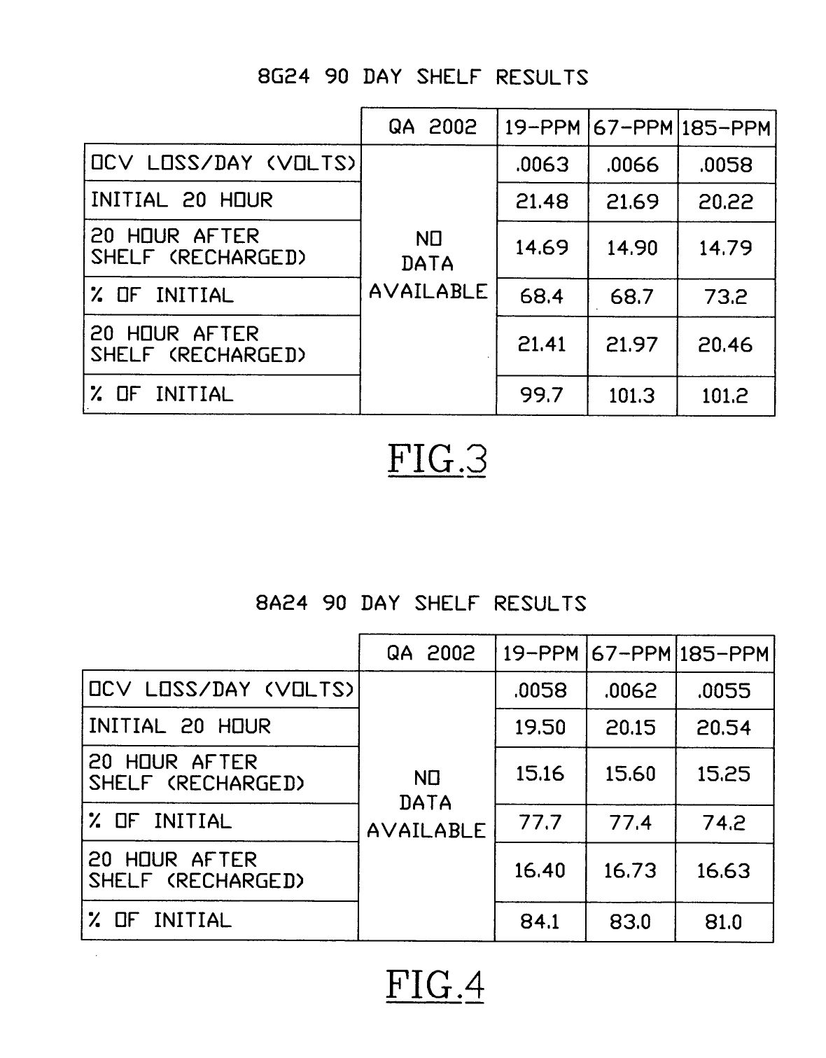

Referring to FIG. 3 the 90-day shelf life test results for the 8G24 group batteries were inconclusive as to whether there is a correlation between the silver level and the shelf life.

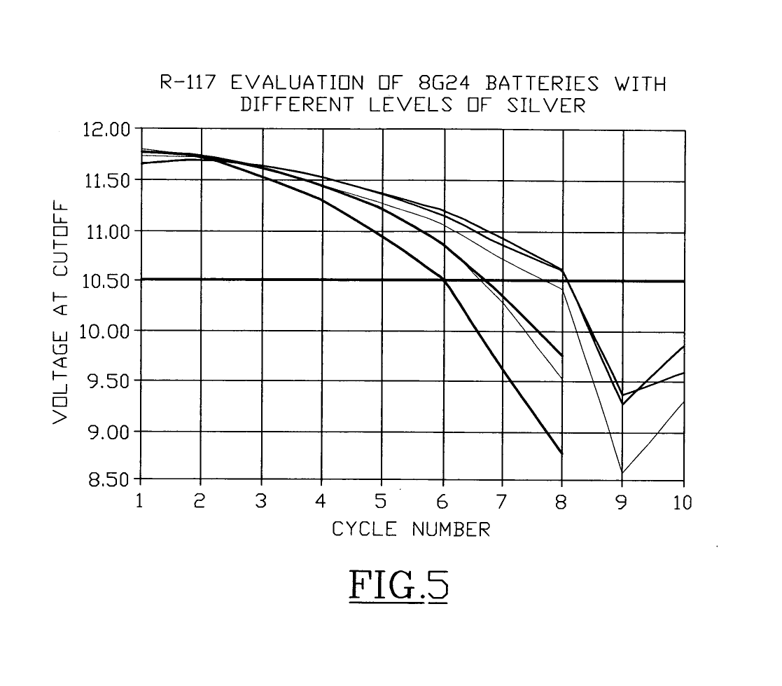

Referring to FIG. 4, the 90-day shelf life test results for the 8A24 group batteries were inconclusive as to whether there is a correlation between the silver level and the shelf life.

Referring to FIG. 5 the graphical representation for the CATV life cycle test results for the 8G24 group batteries shows that there is a correlation between the silver oxide level and CATV life performance.

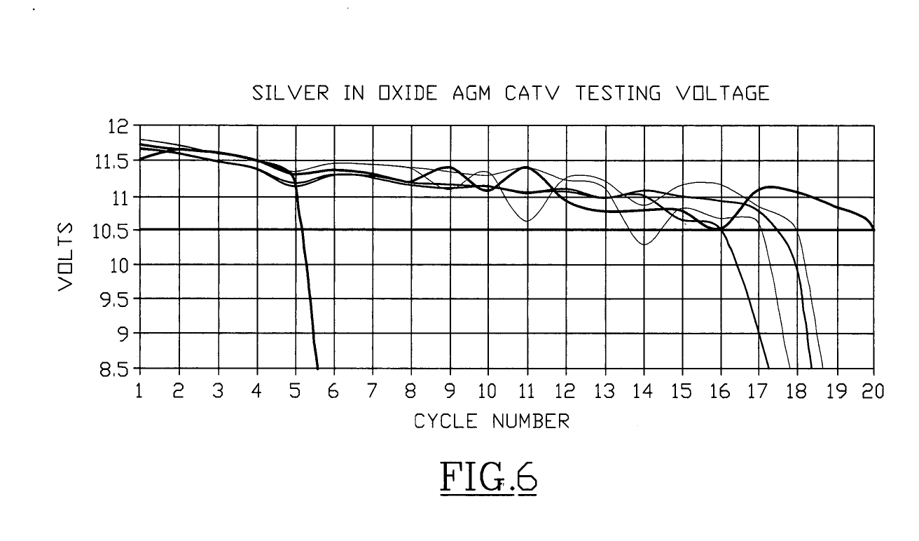

Referring to FIG. 6 the graphical representation for the CATV life cycle test results for the 8A24 group batteries shows very little difference in life cycles versus silver oxide levels.

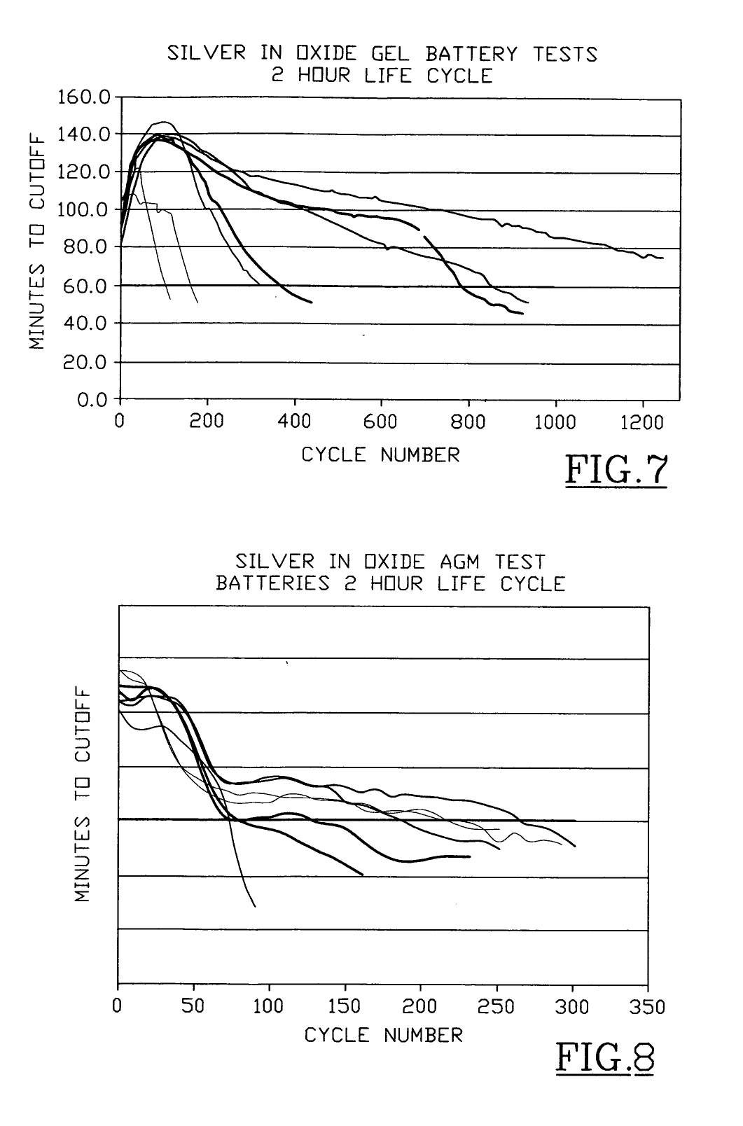

Referring to FIG. 7 the graphical representation for the 2-hour life cycle tests results for the 8G24 batteries shows that there is a correlation between the silver oxide level and cycle life performance. It was clearly demonstrated that silver at 67 PPM improved the cycle life performance for gel batteries. One of the 67 PPM batteries failed prior to the end of the tests, however the other 67 PPM battery had completed in excess of 1250 cycles when the tests were concluded, and it was believed that the tests could have continued.

Referring to FIG. 8, the graphical representation for the 2-hour life cycle test results for the 8A24 group batteries shows that there is a correlation between the silver oxide level and cycle life performance. For the 8A24 group (AGM) batteries the more silver the better the cycle life with one of the 67 PPM batteries providing the best results.

For the 8G24 group (gel) batteries the addition of silver to the lead paste appears to enhance the battery performance up to the 67 PPM silver level. Both the 19 PPM and 67 PPM silver level batteries outperformed the QA battery in the 6-hour, and 20-hour performance as shown in FIG. 1, and in the 2-hour capacity life cycling.

For the 8A24 group (AGM) batteries the addition of silver oxide appeared to enhance all the results. The 90 day shelf life test results showed little difference between the results obtained for the various silver levels, the 20-hour capacity life cycle test results showed that the lowest silver level gave the poorest results, however these results were still better than the control test results.

It will thus be seen that the objects of the invention have been attained.

I claim:

1. In a gel type lead-acid battery having lead plates the improvement which comprises;
adding silver oxide to the lead in an amount in the range of 19 to 67 PPM.

2. In an absorbent glass mat (AGM) type lead acid battery having lead plates, the improvement which comprises;
adding silver oxide to the lead in an amount in the range of 19 to 185 PPM.
